(19) United States
(12) Patent Application Publication
(10) Pub. No.: US 2009/0021655 A1
(43) Pub. Date: Jan. 22, 2009

(54) Conversion Apparatus for a Mounting System

(75) Inventor: James D. Walters, Saint Charles, IL (US)

Correspondence Address: FOLEY & LARDNER LLP, 321 NORTH CLARK STREET, SUITE 2800, CHICAGO, IL, 60610-4764, US

(73) Assignee: Peerless Industries, Inc.

(21) Appl. No.: 12/172,005

(22) Filed: Jul. 11, 2008

Related U.S. Application Data
(60) Provisional application No. 60/959,873, filed on Jul. 17, 2007.

(51) Int. Cl. H04N 5/64

(52) U.S. Cl. 348/839; 348/E05.128

(57) ABSTRACT

A conversion system for mounting a flat panel display device to a portion of an existing CRT mounting system that has previously been mounted on a mounting surface. The conversion system can utilize portions of existing CRT mounting systems, including a previously installed wall arm, wall arms and/or ceiling extension column(s) from CRT mounts. One more display brackets are operatively connected to a mounting plate, which is operatively connected to an adapter box. The adapter box is configured to couple to an extension column, which is adapted to connect to a portion of the existing CRT mounting system.

### CROSS-REFERENCE TO RELATED APPLICATIONS

The present application claims priority to U.S. Provisional Patent Application No. 60/959,873, filed Jul. 17, 2007 and incorporated herein by reference in its entirety.

### FIELD OF THE INVENTION

The present invention relates generally to mounting systems. More particularly, the present invention relates to a conversion apparatus for flat panel mounting systems.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Cathode ray tube (“CRT”) televisions, also referred to as “tube” televisions, have been used and sold for many years, and countless units have been sold nation-wide and around the world. In recent years, however, flat panel televisions have become increasingly popular in both the commercial and residential sectors. As the prices for plasma and liquid crystal display (“LCD”) flat panel displays have continued to fall, and as the quality of devices has improved, more and more businesses and individuals have purchased such devices for both home entertainment and business purposes.

Conventional CRT televisions have a relatively large depth such that placement options for such devices are quite limited. In the residential setting, most users require a television stand or large entertainment center to house the television. Such stands or entertainment centers can take up significant floor space, which is often undesirable. In commercial or educational settings, users will often install large overhead mounting systems that can contain the television. These systems often require professional installation and, once the television is secured to the mount, it is often difficult to access and adjust the television due to its height.

Given the decades-long prevalence of CRT televisions, many new flat panel display owners are previous owners of CRT televisions. Additionally, many of these owners had their CRT televisions mounted to a wall or ceiling using overhead mounting systems. For such owners, the switch from a CRT television to a flat panel unit poses special problems. To switch to a flat panel display and utilize its thin feature by mounting it directly to the wall or ceiling, an owner typically must remove the old CRT mounting system and install a new mounting system specifically designed for flat panel displays. However, uninstalling the CRT mounting systems can be just as difficult as the initial installation, since they are often affixed into the wall or attached through the ceiling. This work is not only cumbersome, but it may also leave unsightly holes on the wall or ceiling in some circumstances.

With the above considerations in mind, it would therefore be desirable to provide a mounting system that allows one to efficiently and resiliently mount a flat panel display to a surface, while reducing the complexity involved in uninstalling a prior CRT television mounting system.

### SUMMARY OF THE INVENTION

Various embodiments of the present invention provide a conversion system for mounting a flat panel display device to a portion of an existing CRT mounting system that was already mounted on a mounting surface for CRT televisions. This conversion system can utilize portions of existing CRT mounting systems, including a previously installed wall arm, wall arms and ceiling extension column(s) from CRT mounts.

In various embodiments, one or more display brackets are operatively connected to a mounting plate, which in turn communicate with an intermediate bracket. The intermediate bracket engages an adapter box. The intermediate bracket and adapter box can cooperate in order to adjust the tilt angle in order to accommodate owners' viewing preferences. The adapter box includes an opening for accepting a portion of an extension column. The extension column retrofits to a portion of a previously installed wall or ceiling CRT mount.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an exploded perspective view of a conversion system according to one embodiment of the present invention;

FIG. 2(a) is a front view of the conversion system of FIG. 1 when in an assembled state; FIG. 2(b) is a bottom view of the conversion system of FIG. 2(a); FIG. 2(c) is a top view of the conversion system of FIG. 2(a); FIG. 2(d) is a right side view of the conversion system of FIG. 2(a); FIG. 2(e) is a left side view of the conversion system of FIG. 2(a); and FIG. 2(f) is a perspective view of the conversion system of FIG. 2(a);

FIG. 3 shows the engagement of the intermediate bracket with the mounting plate in one embodiment of the invention;

FIG. 4 shows the engagement of the adapter box with the intermediate bracket after the intermediate bracket has been engaged with the mounting plate;

FIG. 5 shows how a portion of a conventional one-arm CRT wall mounting system can be used to mount a flat panel display using a conversion system according to one embodiment of the present invention;

FIG. 6 shows how a portion of a conventional two-arm CRT wall mounting system can be used to mount a flat panel display using a conversion system according to one embodiment of the present invention;

FIG. 7 shows how a portion of a conventional ceiling CRT mounting system can be used to mount a flat panel display using a conversion system according to one embodiment of the present invention; and

FIG. 8 is a flow chart illustrating a process for mounting a flat panel display device to a portion of an existing wall or ceiling mounting system according to various embodiments of the present invention.

### DETAILED DESCRIPTION OF VARIOUS EMBODIMENTS

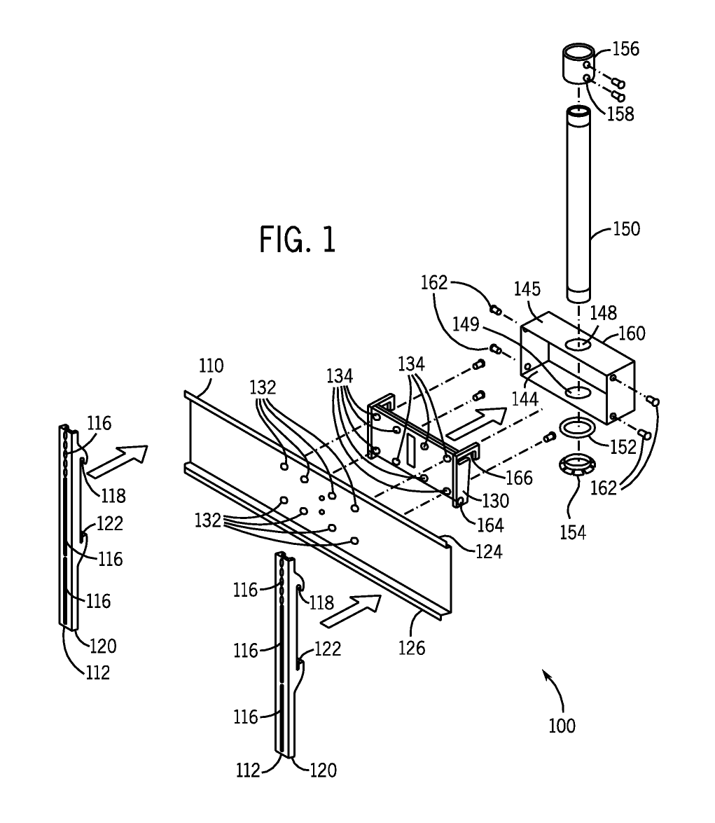

FIG. 1 illustrates a conversion system 100 for mounting a flat panel display to at least a portion of a previously installed CRT mounting system according to one embodiment of the present invention. The conversion system 100 comprises a mounting plate 110 operatively connected to an intermediate bracket 130, which itself operatively connects to an adapter box 160. At least one display bracket 120 connects to the mounting plate 110, with each display bracket 120 being connected to a flat panel display or similar device.

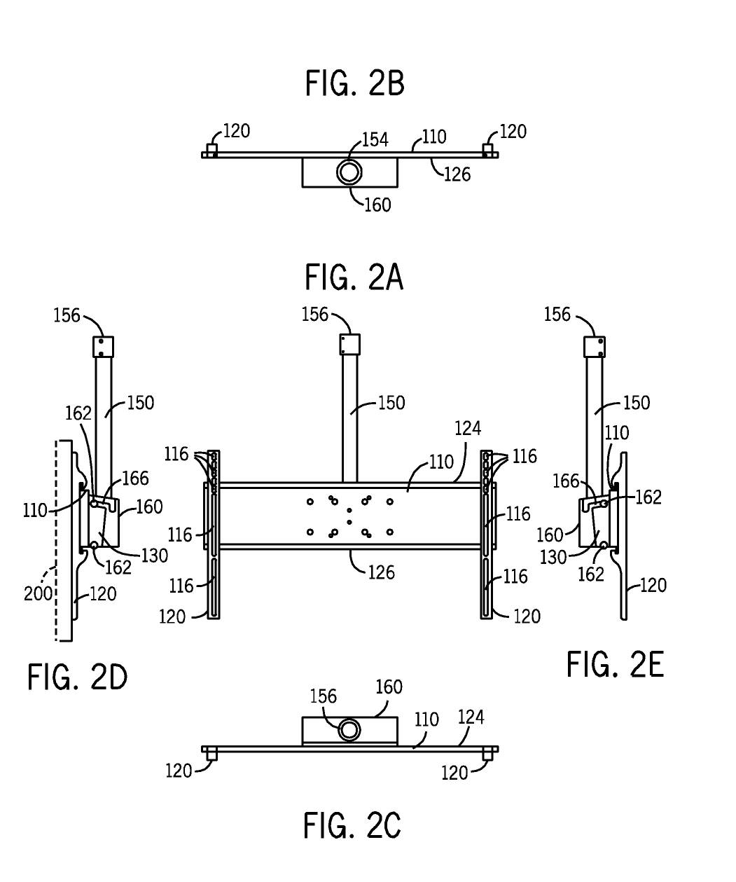

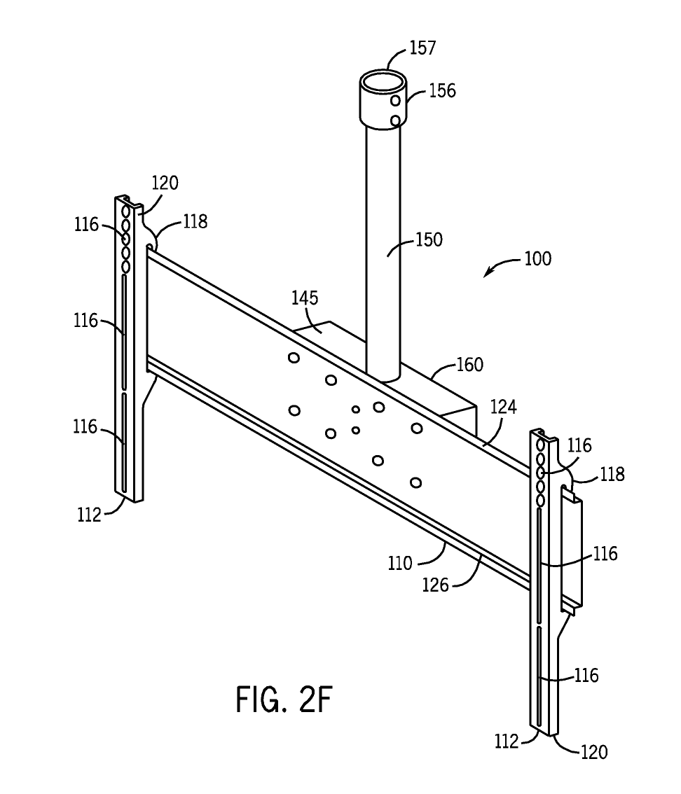

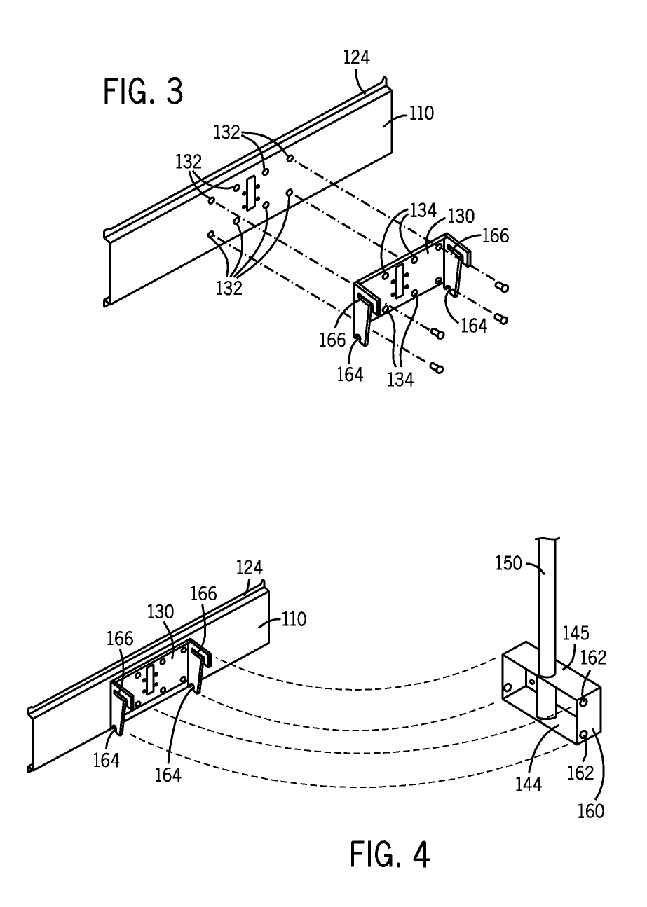

Each display bracket 120 can take a variety of shapes. For example, the display bracket 120 may be elongated, such as in the manner shown in FIG. 1, or it may comprise a broader plate. Each display bracket 120 of the type shown in FIG. 1 comprises a mounting contact portion 112 and one or more side portions 114. The side portions 114, in a particular embodiment, are substantially perpendicular to the mounting contact portion 112. In other embodiments, it is also possible for the side portions 114 to be at a non-perpendicular angle to the mounting contact portion 112. The mounting contact portion 112 and the pair of side portions 114 may be formed as a single piece of material, such as aluminum or steel. In other embodiments, it is also possible for the mounting contact portion 112 and the side portions 114 to be formed as separate components which are later coupled together. The mounting contact portion 112 includes a plurality of mounting slots 116 formed therein. The mounting slots 116 are used to couple the display bracket 120 to a flat panel display (shown in phantom at 200 in FIG. 2(d)) in one embodiment of the invention. Mounting slots 116 are strategically sized and positioned for accepting bolts, screws, or other affixing devices. It should be noted that, in various embodiments, the mounting slots 116 are substantially vertically spaced and commensurate with standard flat panel display spacing for the purposes of effectuating a convenient and secure attachment.

Each display bracket 120 includes an upper hook 118 and a lower guiding portion 122 on each side portion 114, which together define a receiving region for first and second retaining portions 124 and 126 of the adapter box 160. It should be noted that the first and second retaining portions 124 and 126 can comprise pieces of material that are separate from the rest of the adapter box 160, or they can be formed as a single component with the remainder of the adapter box 160.

As illustrated in FIGS. 1, 2(a) and 2(f), for example, each display bracket 120 engages the mounting plate 110 in various embodiments. The display device is secured to each display bracket 120. As shown in FIGS. 2(a)-2(f), one embodiment of the conversion system 100 employs two display device brackets 120, horizontally spaced from each other so as to transfer the weight of the display device to the mounting plate 110 in an approximately balanced manner.

In the embodiment illustrated in FIG. 1, the mounting plate 110 is secured to the intermediate bracket 130 via a plurality of mounting bracket openings 132 and intermediate bracket openings 134, both of which are sized and positioned for accepting bolts, screws, or other affixing devices. The mounting bracket openings 132 and intermediate bracket openings 134 may be vertically and horizontally spaced commensurate with mounting locations that result in improved stability for the conversion system as a whole.

As is illustrated in FIG. 1, an extension column 150 may be vertically inserted into upper and lower column extension regions 148 and 149 on upper and lower horizontal surfaces 145 and 144 of an adapter box 160, respectively. A washer 152 and an end cap 154, or other securing arrangements, may be used to secure the extension column 150 into a proper position within the adapter box 160.

An extension column connector 156 may be secured to the top of the extension column 150, via a plurality of connector openings 158 and extension column openings 158 for accepting bolts, screws, or other affixing devices. The extension column connector 156 can then in turn be connected to an additional column (not shown) which is suspended from the ceiling. More particularly, the extension column connector 156 may be secured to ceiling mount columns from old CRT mounting systems so that the entire CRT mounting system does not have to be removed. The extension column connector 156 may include a plurality of internal threads 157 for use in mating with corresponding threads on the extension column 150 and/or threads on the corresponding portion of the CRT mounting system to which the extension column connector 156 attaches.

In one embodiment and as shown in FIG. 4, the intermediate bracket 130 and the adapter box 160 are tiltably engageable with each other in order to permit the tilt angle of an attached flat panel display to be adjusted. In particular, the adapter box 160 includes a plurality of adapter box fasteners 162, with two such adapter box fasteners 162 near the upper surface of the adapter box 160 and two such adapter box fasteners 162 near the lower surface in one embodiment. The lowermost of the adapter box fasteners 162 are sized to engage a pair of lower intermediate bracket slots 164, and the uppermost of the adapter box fasteners 162 are sized to engage a pair of upper intermediate bracket slots 166. The upper intermediate bracket slots 166 are designed to define a path of travel for the intermediate bracket 130 and the various components connected thereto. With the lower intermediate bracket slots 164 not permitting any translational movement, the intermediate bracket 130 can effectively tilt about an axis defined by the lower intermediate bracket slots 164. In one particular embodiment, this permits adjustment to a tile angle ranging from about zero degrees to about twenty degrees in one embodiment, although other tilt ranges can also be recognized. In the event that user wants to impart additional frictional resistance between the intermediate bracket 130 and the adapter box 160, or if the user wants to fix the position of the intermediate bracket 130 relative to the adapter box 160, the user only has to tighten the adapter box fasteners 162. In an alternate embodiment, the intermediate bracket 130 may not be tiltable or rotatable relative to the adapter box 160, instead having a single fixed position when engaging the adapter box 160. If the position is to be fixed, is also possible to eliminate the intermediate bracket 130 entirely, instead having the mounting plate 110 directly attach to the adapter box 160.

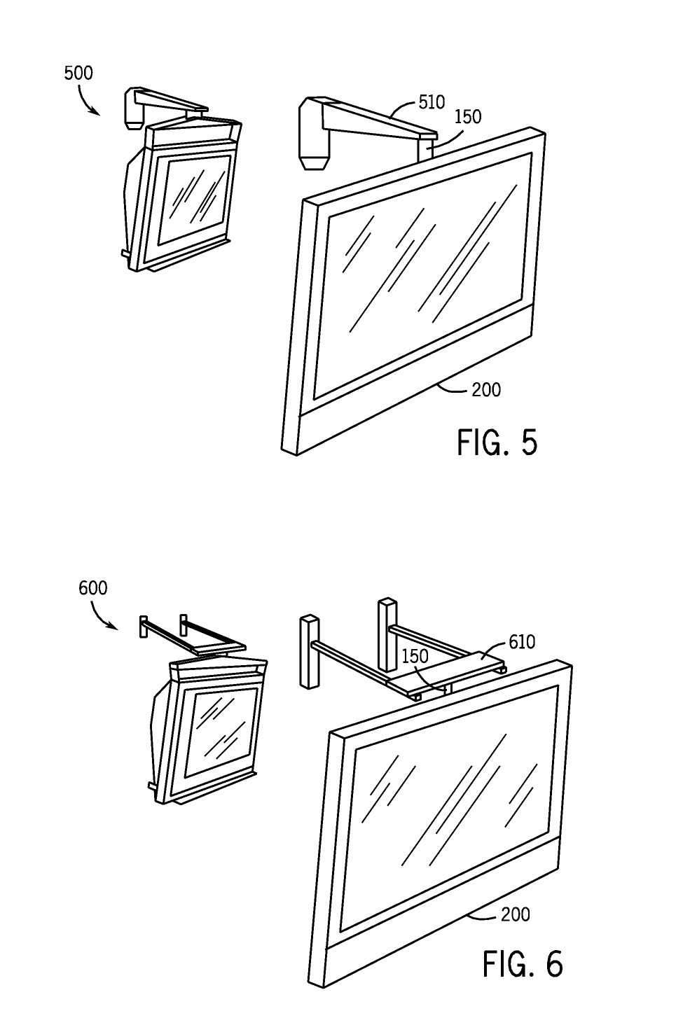

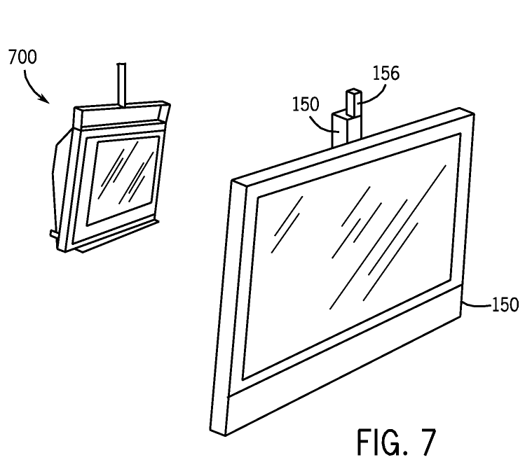

FIGS. 5-7 show how the conversion system 100 described about can be used with a number of different previous CRT mounting system portions. In FIG. 5, the conversion system is used in conjunction with a conventional “single arm” wall mounting system 500, with the extension column 150 securing to an arm member 510 thereof. In FIG. 6, the conversion system 100 is used in conjunction with a conventional “dual arm” wall mounting system 600, with the extension column 150 securing to a lateral member 610 thereof. In both FIGS. 5 and 6, the extension column 150 includes threaded portions via which the extension column can mate with the respective portions of the old single arm and dual arm mounting systems 500 and 600. In FIG. 7, the conversion system 100 is used in conjunction with a conventional ceiling mounting system 700, with the extension column 150 and extension column connector 156 being used to connect to a ceiling column from the previous CRT ceiling mounting system 700.

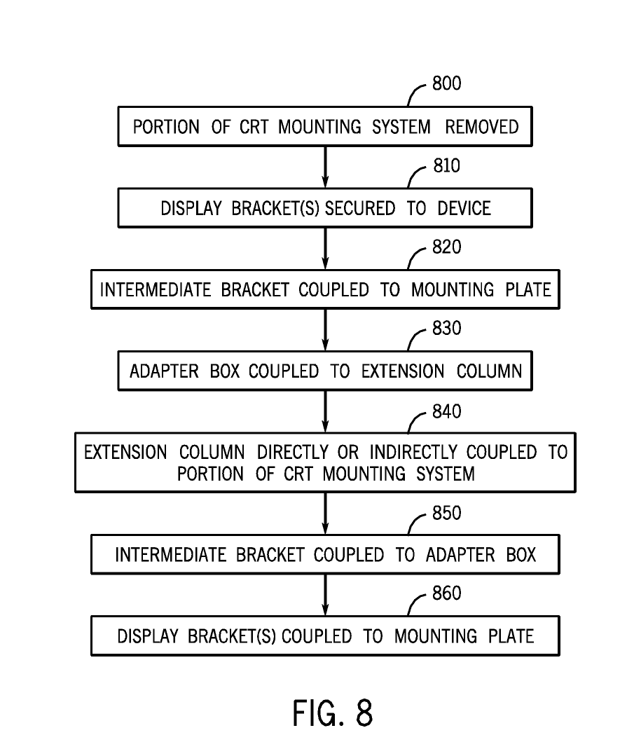

FIG. 8 is a flow chart showing a process by which the conversion system 100 may be used according to various embodiments of the present invention. At 800, when a user desires to mount a flat panel display device to a wall, ceiling or other mounting surface using part of an already-installed CRT mounting system, the user first removes an unneeded portion of the original CRT mount. At 810, the user secures the desired number of display brackets 120 to the back of the display device. At 820, the user attaches the intermediate bracket 130 to the mounting plate 110. The user connects the adapter box 160 to the extension column 150 at 830 and, at 840, directly or indirectly couples the extension column 150 to the still-useful portion of the old CRT mounting system, either directly or through the use of the extension column connector 156. At 850, the user connects the intermediate bracket 130 to the adapter box 160, tightening the adapter box fasteners 162 as necessary. At 860, the user secures the display brackets 120 (with display device attached) to the mounting plate 110. The display brackets 120 can also be locked into place through the use of fasteners (not shown) such as screws. It should also be noted that, the order of some of these processes can be changed in ways that would be understood by those skilled in the art.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. For example, it is possible for intermediate components or structures to operatively connect certain of the components described above to each other, instead of using the direct attachments described above. More particularly, an intermediate component may be positioned between the intermediate bracket 130 and the mounting plate 110, or between the intermediate bracket 130 and the adapter box 160. The embodiments were chosen and described to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus and systems.

What is claimed is:

1. A conversion system for mounting a display device, comprising:
at least one display bracket configured to operatively connect to the display device;
a mounting plate operatively engageable with the at least one display bracket;
an intermediate bracket operatively connected to the mounting plate; and
an adapter box operatively connected to the intermediate bracket, the adapter box configured to operatively connect to a portion of an existing cathode ray tube (CRT) mounting system.

2. The conversion system of claim 1, wherein the intermediate bracket is tiltable relative to the adapter box when operatively connected thereto.

3. The conversion system of claim 1, further comprising an extension column engageable with the adapter box, and wherein the adapter box is configured to operatively connect to the portion of the existing CRT mounting system via the extension column.

4. The conversion system of claim 3, further comprising an extension column connector, the extension column connector engageable with the extension column and the portion of the existing CRT mounting system.

5. The conversion system of claim 1, wherein the intermediate bracket is directly attached to the mounting plate.

6. The conversion system of claim 1, wherein the intermediate bracket is directly attached to the adapter box.

7. A conversion system, comprising:
a flat panel display device;
at least one display bracket configured to operatively connect to the flat panel display device;
a mounting plate operatively engageable with the at least one display bracket;
an intermediate bracket operatively connected to the mounting plate; and
an adapter box operatively connected to the intermediate bracket, the adapter box configured to operatively connect to a portion of an existing cathode ray tube (CRT) mounting system.

8. The conversion system of claim 7, wherein the intermediate bracket is tiltable relative to the adapter box when operatively connected thereto.

9. The conversion system of claim 7, further comprising an extension column engageable with the adapter box, and wherein the adapter box is configured to operatively connect to the portion of the existing CRT mounting system via the extension column.

10. The conversion system of claim 9, further comprising an extension column connector, the extension column connector engageable with the extension column and the portion of the existing CRT mounting system.

11. The conversion system of claim 7, wherein the intermediate bracket is directly attached to the mounting plate.

12. The conversion system of claim 7, wherein the intermediate bracket is directly attached to the adapter box.

13. A method of mounting a display device to a portion of a previously-installed mounting system, comprising:
(a) removing a first portion of the previously installed mounting system from a second portion of the previously installed mounting system, the second portion of the previously installed mounting system remaining secured to a mounting surface;
(b) operatively connecting at least one display bracket to a display device;
(c) operatively connecting an adapter box to the second portion of the previously installed mounting system;
(d) operatively connecting a mounting plate bracket to the adapter box; and
(e) operatively connecting the at least one display bracket to the mounting plate.

14. The method of claim 13, wherein processes (a)-(e) occur sequentially.

15. The method of claim 13, wherein the mounting plate is coupled to the adapter box via an intermediate bracket.

16. The method of claim 15, further comprising tilting the intermediate bracket to a desired angle relative to the adapter box.

17. The method of claim 15, wherein the intermediate bracket is directly attached to the mounting plate.

18. The method of claim 15, wherein the intermediate bracket is directly attached to the adapter box.

19. The method of claim 13, wherein the operative connecting of the adapter box to the second portion of the previously installed mounting system comprises:
connecting the adapter box to an extension column; and
operatively connecting the extension column to the second portion of the previously installed mounting system.

20. The method of claim 17, wherein the operative connecting of the extension column to the second portion of the previously installed mounting system comprises:
connecting a first end of an extension column connector to one end of the extension column; and
connecting a second end of the extension column connector to an exposed column of the second portion of the previously installed mounting system.
